(19) United States
(12) Patent Application Publication
(10) Pub. No.: US 2002/0004839 A1
(43) Pub. Date: Jan. 10, 2002

(54) Method of controlling the display of a browser during a transmission of a multimedia stream over an internet connection so as to create a synchronized convergence platform

(76) Inventors: William Wine, Toronto (CA); Manfred Humphries, Toronto (CA)

Correspondence Address: Patricia Smink Rogowski, Connolly Bove Lodge & Hutz LLP, P.O. Box 2207, Wilmington, DE, 19899, US

(21) Appl. No.: 09/851,605

(22) Filed: May 9, 2001

Related U.S. Application Data
(60) Provisional application No. 60/203,046, filed on May 9, 2000.
(60) Provisional application No. 60/259,376, filed on Jan. 2, 2001.

(51) Int. Cl. G06F 15/16

(52) U.S. Cl. 709/231; 709/203

(57) ABSTRACT

The present invention relates generally to a system and method of controlling the display of sponsoring, advertising and/or hyperlinks or other web page controls during a multimedia stream transmission over an Internet connection. Specifically, sponsoring, advertising and/or hyperlinks to accompany multimedia stream transmissions are selected so that they are “thematically appropriate” or “in context” with the content of the multimedia stream. In this way, the content of the sponsor, advertisement and/or hyperlink material is more likely to be properly targeted to the multimedia stream viewing audience. The presentation of the multimedia stream transmission is further enhanced by hyperlinks to related web sites associated with terms being used, details of particular topics, information on particular entities, and other view points.

### RELATED APPLICATIONS

This application claims the benefit of U.S Provisional Patent Application serial No. U.S. 60/203,046 filed May 9, 2000 and U.S Provisional Patent Application serial No. 60/259,376 filed Jan. 2, 2001; and which contents are further incorporated by reference.

### FIELD OF THE INVENTION

The present invention relates in general to multimedia stream transmissions and more specifically to a system and method of controlling the display of accompanying content during a multimedia stream transmission over an Internet connection.

### CLAIM TO COPYRIGHT

A portion of the disclosure of this patent document contains material, which is subject to copyright protection. The copyright owner has no objection to the facsimile reproduction by anyone of the patent document, as it appears in the Patent and Trademark Office patent file or records, but otherwise reserves all copyright rights whatsoever. In respect of the appended code, for greater certainty, all materials contained therein have the following copyright notice: “Copyright© 2000 I LOVE TV INC. (868970 Ontario Inc.) All rights reserved”.

### BACKGROUND OF THE INVENTION

Until recently, users wishing to view a multimedia stream transmission were required to sit in front of a television set. However, with the emergence of the Internet, users are now able to watch multimedia stream transmissions through multimedia stream client applications such as web browsers executing on personal computers. In addition to viewing multimedia stream transmissions, browsers also accommodate multi-tasking. Thus, users can communicate with other users in chat rooms or “surf the Net” while watching multimedia stream transmissions.

Similar to multimedia stream transmissions viewed on television sets, in many cases, multimedia streams transmitted over the Internet include sponsoring, advertising and/or hyperlinks that are displayed by the multimedia stream client application. Prior art multimedia stream client applications, such as RealPlayer® sold by RealNetworks Inc., display advertising in a frame surrounding the window through which the multimedia stream transmission is viewed. This advertising is displayed during allotted time slots along the multimedia stream transmission.

The allotted time slots are typically pre-purchased by businesses. In this manner, a schedule for the advertising and any other information that is to accompany the multimedia stream transmission can be developed. Unfortunately, since the schedule of advertising and other information is developed based on the pre-purchased allotted advertising time slots, the advertising and other information displayed during these time slots often does not relate to the content of the multimedia stream transmission. This of course can limit the effectiveness of the advertising.

It is therefore an object of the present invention to provide a novel system and method of controlling the display of a accompanying content during a multimedia stream transmission over an Internet connection.

### SUMMARY OF THE INVENTION

The present invention relates generally to a system and method of controlling the display of sponsoring, advertising and/or hyperlinks or other web page controls during a multimedia stream transmission over an Internet connection. Specifically, sponsoring, advertising and/or hyperlinks to accompany multimedia stream transmissions are selected so that they are “thematically appropriate” or “in context” with the content of the multimedia stream. In this way, the content of the sponsor, advertisement and/or hyperlink material is more likely to be properly targeted to the multimedia stream viewing audience. The presentation of the multimedia stream transmission is further enhanced by hyperlinks to related web sites associated with terms being used, details of particular topics, information on particular entities, and other view points. This convergence platform enhances the presentation of multimedia stream transmissions for a number of uses including, education, political discussion, and entertainment. The accompanying sponsoring, advertising and/or hyperlinks may take the form of banners, uniform resource locators (URLs) or other suitable forms.

According to one aspect of the present invention there is provided a method of controlling a display of accompanying content during a multimedia stream transmission over an Internet connection comprising the steps of: selecting thematically appropriate content to accompany the multimedia stream; and dynamically changing the accompanying content during the transmission of the multimedia stream so that the displayed accompanying content is thematically appropriate for the content of the multimedia stream being displayed.

In one embodiment, during the selecting step, a control file is created that includes triggers corresponding to changes in the content of the multimedia stream transmission. The advertising is changed in response to the triggers. The triggers in a preferred embodiment are VBI tokens having timestamps corresponding to points along the multimedia stream transmission at which the content thereof changes.

According to another aspect of the present invention there is provided a system for controlling a display of accompanying content during a multimedia stream transmission over an Internet connection, the system comprising: a selector to select thematically appropriate content to accompany a multimedia stream; and a multimedia server to dynamically change the accompanying content during the multimedia stream transmission so that the displayed accompanying content is thematically appropriate for the content of the multimedia stream being displayed.

According to another aspect of the present invention there is provided a computer program product including a computer readable medium having a computer program recorded therein for controlling a display of accompanying content during a multimedia stream transmission over an Internet connection, the computer program comprising: computer program code to select thematically appropriate content to accompany a multimedia stream; and computer program code to dynamically change the accompanying content during the transmission of the multimedia stream so that the displayed accompanying content is thematically appropriate for the content of the multimedia stream being displayed.

According to another aspect of the present invention there is provided a method of controlling a display of accompanying content during a transmission of a multimedia stream over an Internet connection comprising the steps of: receiving commercial information associated with the multimedia stream; locating tokens corresponding to accompanying content in the commercial information; accessing a database for data that is thematically appropriate to the accompanying content; creating a control file based on the accompanying content; forwarding the control file to a multimedia server for coordination with the transmission of the multimedia stream; and executing the control file during transmission of the multimedia stream; wherein execution of the control file dynamically controls the location and subject matter of accompanying content displayed during the transmission of the multimedia stream so that the displayed accompanying content is thematically appropriate with the content of the multimedia stream being displayed.

According to another aspect of the present invention there is provided a method of producing a multimedia stream for transmission over an Internet connection to a web browser, the multimedia stream including an audio-visual stream and accompanying content, the method comprising: receiving a signal comprising the audio-visual stream and vertical blanking intervals, the vertical blanking intervals comprising textual information on the contents of the audio-visual stream where the textual information is substantially synchronized with the contents of the audio-visual stream; extracting the textual information and synchronization timing of the textual information in relation to the audio-visual stream from the signal; selecting accompanying content associated to at least one of the textual information and user preferences of the web browser; formatting the accompanying content into VBI tokens; and encoding the audio-visual stream and the VBI tokens where the accompanying content is presented and changed according to the VBI tokens by the web browser so that the accompanying content is in substantial synchronization with presentation of the contents of the audio-visual stream.

According to another aspect of the present invention there is provided a method of producing a multimedia stream for transmission over an Internet connection to a web browser, the multimedia stream including an audio-visual stream and accompanying content, the method comprising: receiving a signal comprising the audio-visual stream and vertical blanking intervals, the vertical blanking intervals comprising textual information on the contents of the audio-visual stream where the textual information is substantially synchronized with the contents of the audio-visual stream; extracting the textual information and synchronization timing of the textual information in relation to the audio-visual stream from the signal; selecting accompanying content associated to at least one of the textual information and user preferences of the web browser; formatting the accompanying content into VBI tokens; and encoding the synchronization timing and the VBI tokens into a control file for storage, and in response to a user request, the control file is retrieved for encoding the audio-visual stream and the VBI tokens where the accompanying content is presented and changed according to the VBI tokens by the web browser so that the accompanying content is in substantial synchronization with presentation of the contents of the audio-visual stream.

According to another aspect of the present invention there is provided a method of presenting a multimedia stream for transmission over an Internet connection to a web browser, the multimedia stream including an audio-visual stream and accompanying content, the method comprising: receiving a signal comprising the audio-visual stream and vertical blanking intervals, the vertical blanking intervals comprising textual information on the contents of the audio-visual stream where the textual information is substantially synchronized with the contents of the audio-visual stream; extracting the textual information and synchronization timing of the textual information in relation to the audio-visual stream from the signal; selecting accompanying content associated to at least one of the textual information and user preferences of the web browser; formatting the accompanying content into VBI tokens; encoding the synchronization timing and the VBI tokens into a control file; storing the control file and the audio-visual stream; receiving a request from the web browser for the multimedia stream and in response retrieving the control file and audio-visual stream; encoding the audio-visual stream and the VBI tokens for the multimedia stream; and transmitting the multimedia stream to the web browser; where the accompanying content is presented and changed according to the VBI tokens by the web browser so that the accompanying content is in substantial synchronization with presentation of the contents of the audio-visual stream.

According to another aspect of the present invention there is provided a method of presenting a multimedia stream and associated VBI tokens received over an Internet connection on a web browser, the multimedia stream including an audio-visual stream, the VBI tokens comprising accompanying content, the method comprising: requesting the multimedia stream from a web portal; connecting to a multimedia server to receive the multimedia stream; receiving the multimedia stream and the VBI tokens from the multimedia server; extracting the audio-visual stream and the VBI tokens; and presenting the audio-visual stream and presenting and changing the accompanying content according to the VBI tokens; where the VBI tokens and the audio-visual stream are encoded such that the accompanying content is presented and changed according to the VBI tokens by the web browser so that the accompanying content is in substantial synchronization with presentation of the contents of the audio-visual stream.

The present invention provides advantages in that unlike prior art systems, the display of content accompanying multimedia stream transmissions is dynamic during the multimedia stream transmissions. In this manner, the accompanying content is not static and is continuously updated. By continuously updating the accompanying content in relation to the multimedia stream transmission, thematically appropriate content is displayed to users.

### BRIEF DESCRIPTION OF THE DETAILED DRAWINGS

Embodiments of the present invention will now be described more fully with reference to the accompanying drawings in which:

FIG. 1 is a schematic diagram of a conventional prior art system for transmitting a multimedia stream to an end user;

FIG. 2 is a schematic diagram of a system for transmitting a multimedia stream to an end user in accordance with the present invention;

FIG. 3 is a flowchart outlining the steps performed by the system of FIG. 2 to select and transmit content to accompany a multimedia stream transmission;

FIG. 4 is a screen display of a web page presenting a multimedia stream transmission and accompanying content; and

FIG. 5 is a schematic diagram of an alternative embodiment of a system for transmitting a multimedia stream to an end user in accordance with the present invention.

### DETAILED DESCRIPTIONS OF THE PREFERRED EMBODIMENTS

The present invention relates generally to a system and method of controlling the display of content accompanying a multimedia stream transmission over an Internet connection. Thematically appropriate content is selected to accompany the multimedia stream transmission. During the course of the multimedia stream transmission, the accompanying content is dynamically changed so that the displayed accompanying content is thematically appropriate for the content of the multimedia stream transmission. For ease of understanding, a conventional system for transmitting a multimedia stream to an end user will firstly be described.

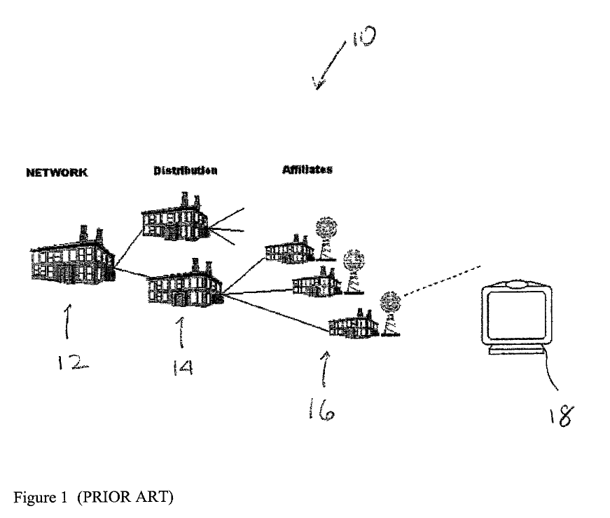

Turning now to FIG. 1, a schematic diagram of a conventional system for transmitting a multimedia stream to an end user is shown and is generally indicated to by reference numeral 10. As can be seen, the system 10 includes a network station 12 at which a list of multimedia streams to be transmitted to viewers is created. The network station 12 forwards the list of multimedia streams to a plurality of distribution centers 14. Each distribution center 14 selects the multimedia streams from the list that they wish to air during the week thereby to create a schedule for that week. After the week has been planned, the schedule is forwarded to a plurality of affiliates 16, or broadcast sources. Each affiliate 16 in turn selects, modifies and/or augments the schedule before transmitting the multimedia streams in the schedule to viewers. Receivers 18 at viewer locations receive and display the multimedia streams.

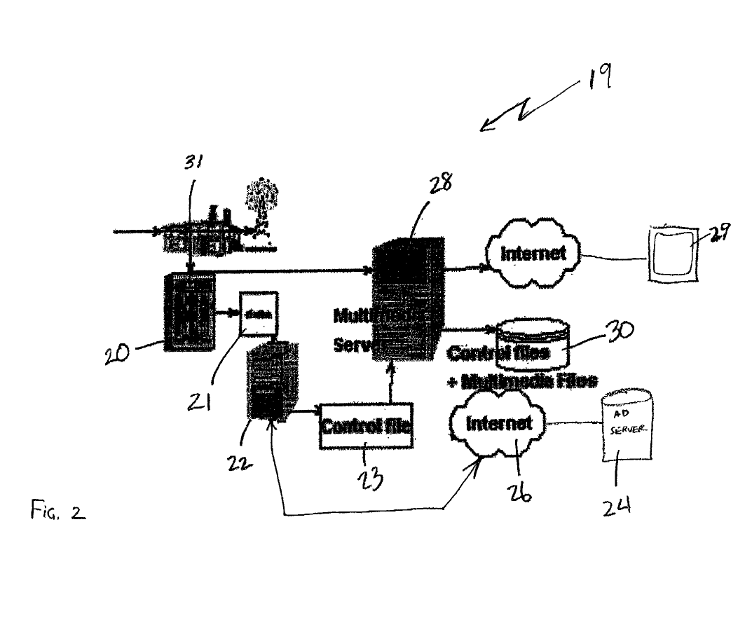

As mentioned previously, the growth of the Internet and multimedia stream client applications designed to permit users to view multimedia stream transmissions over Internet connections have increased the popularity of multimedia streaming. This has provided an opportunity to present accompanying content to viewers in a manner more effective than has been achieved in the past. An embodiment of the present invention will now be described with particular reference to FIGS. 2 to 4.

Turning now to FIG. 2, a system for selecting and transmitting thematically appropriate content to accompany a multimedia stream transmission over an Internet connection for display by a multimedia stream client application in accordance with the present invention is shown and is generally indicated to by reference numeral 19. As can be seen, the system 19 includes a co-ad server 22 that receives commercial information 21 from a decoder 20 housed by a network center, a distribution center or an affiliate 31 (“associate”). The co-ad server 22 is connectable to an ad server 24 via an Internet connection 26 and is also connected to a multimedia server 28. The multimedia server 28 receives a multimedia stream transmission in the form of an NTSC/PAL/SECAM television broadcast signal from the associate 31 and is connected to a transmission database 30. The multimedia server 28 also establishes connections to personal computers 29 executing multimedia stream client applications (“browsers”) over Internet connections 26.

The broadcast signal includes an audio-visual stream and vertical blanking intervals (“VBIs”). The VBIs have low-speed and high-speed data channels that provide a data carrying capability bandwidth of 5.7 megabytes per second. VBIs are most often used by broadcasters to carry closed captioning data for the hearing impaired. However, closed captioning, even if fully deployed, does not use a bandwidth exceeding 100 kilobytes per second. This leaves 5.6 megabytes of spare data carrying capability, which the present invention utilizes.

Specifically, in accordance with the present invention, VBI tokens are inserted into VBIs of the broadcast signal. The VBI tokens are used for a number of purposes. One purpose is to relate content of material that is to accompany the multimedia stream to: the content of the multimedia stream; predetermined features or procedures in the multimedia stream; predetermined timed moments or intervals along the multimedia stream; and landmarks in the multimedia stream.

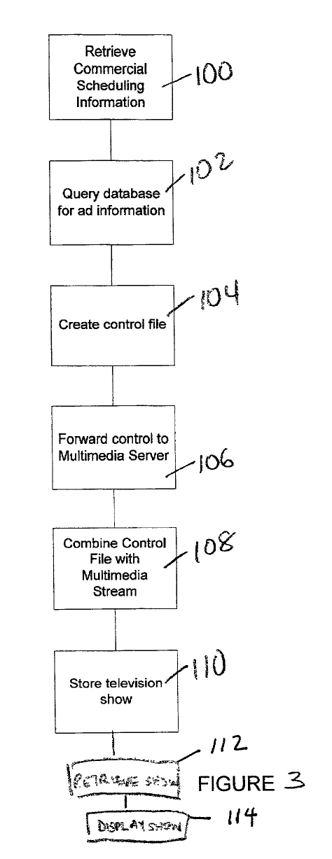

Turning to FIG. 3, a flowchart is shown outlining the steps performed by the system 19 to select and transmit thematically or contextual accompanying content with a multimedia stream transmission over an Internet connection. When a multimedia stream is to be transmitted over the Internet to end users for display on browsers executed by personal computers 29, the co-ad server 22 accesses the decoder 20 to retrieve commercial information 21 stored in the form of VBI tokens (step 100). The VBI tokens represent content that is to accompany the multimedia stream if the content is thematically appropriate or in context with the content of the multimedia stream. Thus, the VBI tokens provide an indication of the context of the accompanying content that the VBI tokens represent.

The VBI tokens are inserted into prescribed areas of the VBIs in accordance with the EIA-608 specification by production personnel at the associate 31. Other information such as closed captioning, electronic program guide information, WebTV data, InteractiveTV data and ATVEF-compliant data are also provided in the VBI tokens.

The decoder 20 decodes the VBI tokens 21 and passes the VBI tokens to a daemon executing on the co-ad server 22. The use of daemons is well known in the art. The daemon searches the VBI tokens 21 for VBI tokens that represent content that is thematically appropriate or in context with the content of the multimedia stream. If the daemon locates such a VBI token, the VBI token is stored in the co-ad server 22 along with a timestamp. The timestamp determines the time along the multimedia stream at which the content represented by the VBI token is to be displayed. The daemon searches all of the VBI tokens so that a set of VBI tokens and respective timestamps is created and stored by the co-ad server 22.

With the set of VBI tokens created, the co-ad server 22 accesses the database of the ad server 24 over an Internet connection 26, and requests thematically appropriate content corresponding to each VBI token in the set (step 102). The content may be in the form of pictures, images, URLs and/or any other form digital data. If no thematically appropriate content corresponding to a VBI token is found in the ad server database, the co-ad server 22 retrieves content from an outside source (i.e. another web page or an ad service) that is thematically appropriate. After each of the VBI tokens in the set has been matched with thematically appropriate content, the set of VBI tokens and associated timestamps, along with the thematically appropriate content, are used by the co-ad server 22 to create a control file 23 (step 104).The control file 23 is then forwarded to the multimedia server 28 (step 106). The multimedia server 28, upon receiving the control file 23 from the co-ad server 22, coordinates the multimedia stream and the control file 23 to yield an encoded multimedia stream (step 108). The encoded multimedia stream and its associated control file is then stored in the transmission database 30 (step 110).

When a multimedia stream is selected for viewing by an end user, the multimedia server 28 retrieves the encoded multimedia stream and the control file 23 from the transmission database 30 (step 112). The encoded multimedia stream is then transmitted to the end user over the Internet connection 26 and displayed on the browser executed by the personal computer 29 (step 114). During transmission, the multimedia server 28 executes the control file 23 to select the appropriate content to accompany the multimedia stream. The content accompanying the multimedia stream is dynamically changed in accordance with the set of VBI tokens and related timestamps stored in the control file 23. If a VBI token change is sensed (i.e. the timestamp for the next VBI token has occurred), it triggers a corresponding change in the appropriate area of the browser so that thematically appropriate content accompanies the multimedia stream being displayed by the browser.

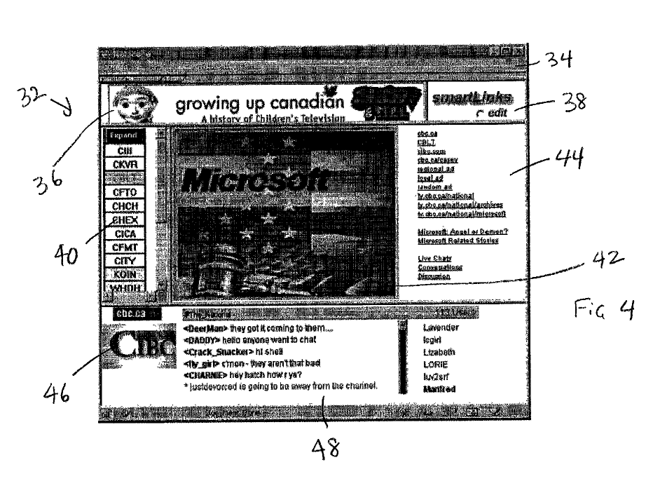

Turning to FIG. 4, a screen display of a browser displaying a multimedia stream transmission is shown and is generally indicated by reference numeral 32. The screen display 32 is a framed Internet web page comprising a menu bar 34 having a plurality of user selectable options, an advertising frame 36, a smartLinks frame 38, a channel selection frame 40, a multimedia stream transmission display frame 42, a links frame 44, a Network/Sponsor frame 46 and a community frame 48, containing a chat box.

The advertising frame 36 presents a banner that is linked to a second advertising page corresponding to the advertisement displayed in the advertising frame 36. The smartLinks frame 38 permits interactivity between the user and previously displayed hyperlinks and provides a bookmark editing facility. The channel selection frame 40 allows the user to select other multimedia streams from a list. The community frame 48 provides a medium for users to communicate with other users. The multimedia stream transmission display frame 42 presents the multimedia stream.

While the multimedia stream is being transmitted, the control file 23 controls the content that is displayed in the advertising frame 36, the links frame 44, and the Network/Sponsor frame 46. This content is thematically appropriate in relation to the multimedia stream presented in the multimedia stream transmission display frame 42. Using the set of VBI tokens and timestamps, the control file 23 dynamically changes the accompanying content so that it corresponds to the content of the multimedia stream being transmitted. For example, if the multimedia stream relates to news on The Toronto Maple Leafs, accompanying content corresponding to the Toronto Maple Leafs is displayed in the advertising frame 36, the links frame 44 and the Network/Sponser frame 46. If the news changes to the Olympics, the accompanying content changes accordingly since the control file associated with the multimedia stream includes a VBI token corresponding to this change in multimedia stream content.

By using the control file 23, accompanying content is dynamically coordinated with the content of the multimedia stream. This provides for enhanced advertising exposure for the sponsors of the accompanying content. Also, users have an editable record accessible via the smartLinks frame 38 of all links related to the content of the multimedia stream, the network, the station and the sponsor, should they wish to visit, at a later time, a site referred to in the multimedia stream content.

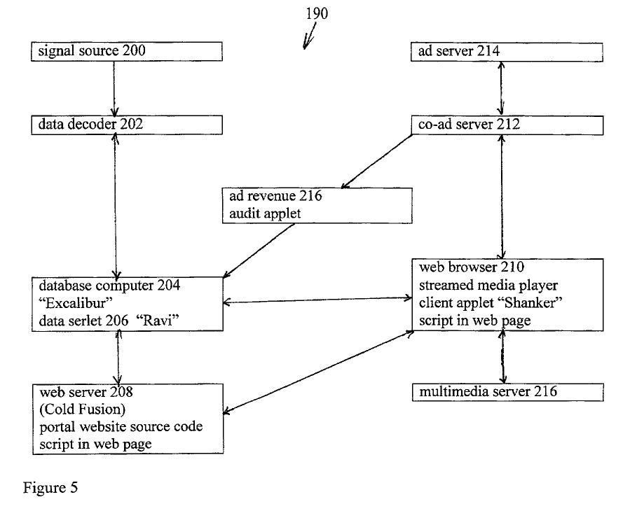

Referring to FIG. 5, there is shown an alternative embodiment of a system 190 for selecting and transmitting appropriate content to accompany a multimedia stream transmission over an Internet connection for display by a multimedia stream client application in accordance with the present invention. System 190 includes a signal source 200, a data decoder 202, such as a TES 3 Norpak decoder, a database computer 204, a data servlet 206 and a web server 208. Web server 208 communicates with personal computers executing web client applications 210 in the form of web browsers. System 190 also includes a co-ad server 212, an ad server 214 and a multimedia server 216.

The signal source 200 transmits a broadcast signal comprised of an audio-visual stream and VBIs. The VBIs include many different types of information in both the low-speed and high-speed channels thereof. This information may include for example, closed captioning data, ATVEF compliant tags or triggers signifying changes in the content of the audio-visual stream, ATVEF compliant textual information on the content of the audio-visual stream, program guide data, station URL, binary formatted files, sound files, image files, and HTML files. The information in the low-speed and high-speed VBI channels is inserted when the broadcast signal is produced.

The broadcast signal is received by the data decoder 202. The data decoder 202 decodes the VBIs to extract the information in the low-speed and high-speed VBI channels. The database computer 204 receives the extracted information and uses the extracted information to select content that is contextually appropriately for the content of the audio-visual stream. The database computer 204 in turn formats the selected content and the audio-visual stream to place the audio-visual stream and selected content into a scheme appropriate for transmission over an Internet connection.

To perform the above actions, the database computer 204 includes a VBI organizer, a data filter, an URL generator, a database, and an enhanced data exporter. In particular, the VBI organizer separates the information in the low-speed and high-speed channels of the VBIs into different elements in the data stream, for subsequent processing by the data filter. The ATVEF compliant tags or triggers are translated into VBI tokens. The data filter filters the VBI tokens, the ATVEF compliant textual information that describes the content of the audio-visual stream, and any other associated information of interest to extract audio-visual stream content data. The extracted content data is then conveyed to the URL generator for processing.

The URL generator analyzes the extracted audio-visual stream content data for indications of the content of the audio-visual stream and any encoded URL/hyperlink information therein. The URL generator in turn generates appropriate hyperlinks depending on the audio-visual stream content if necessary or desired. In order to generate the hyperlinks, the URL generator uses the text of the closed captioning data and/or the text of the textual information to search thesaurus databases for related hyperlinks. The thesaurus databases may include for example, web search engines available over the Internet.

In addition, the database computer 204 retrieves advertisements and links to advertisements from the co-ad server 212 database according to the textual information. The advertisements and links to advertisements retrieved from the co-ad server database, and hyperlinks generated by the URL generator form the content to accompany the audio-visual stream and are formatted by the database computer 204 into VBI tokens. The VBI tokens further include commands that when executed by web browsers 210 effect the presentation of the accompanying content.

The database computer 204 further generates VBI tokens according to the textual information, which instruct the web browsers 210 to obtain advertisements from an outside agency, for example, a web site of an advertiser or to a co-ad server 212 or co-ad servers. The co-ad server 212, or co-ordination server, co-ordinates the advertisement provided to the web browsers 210. The co-ordination function includes, for example, obtaining the up to date versions of the advertisements from the ad server 214 of an advertiser; and determining the appropriateness of the advertisements for a web browser based on the client or user profile and/or location. An example is that of an advertisement for a user in France should be in French and not English. Another example is that an advertiser may have several different advertisements depending on the locality like Canada versus the U.S.A.

The database computer 204 further generates synchronization timing information, such as time stamps relative the beginning of an audio-visual stream, that determines when VBI tokens are to be displayed on the web browsers 210 so that related accompanying content is synchronized with the content of the audio-visual stream.

The enhanced data exporter exports display data, including the VBI tokens and the synchronization timing information into a control file. The control file contains the data needed by servlets and applets to control the browsers 210 executed by personal computers. Each change to a display of the web browser 210 thus has synchronization timing information relative to the beginning of an audio-visual stream (“program”).

For a program that is to be stored for later retrieval; the synchronization timing information, the VBI tokens, and the rest of the display information are stored in a control file associated with that program. For a program that is to be broadcast live; the synchronization timing information, VBI tokens, and other display information are contemporaneously sent to the client web browsers 210 with the transmission of the program.

The web server 208 acts as a hub to connect the various parts of the system 190. When a user wishes to view a program, the web browser 210 sends a request for the program to a web portal of the web server 208. The web server 208 in response provides instructions to the web browser 210 to connect with the data servlet 206 to receive the program. The web server 208 then initiates the data servlet 206 to retrieve the audio-visual stream and the associated control file. Using the control file, an encoded multimedia stream is generated by the data servlet 206. This is achieved by inserting VBI tokens at appropriate locations in the audio-visual stream using the synchronization timing information in the control file to synchronize the presentation of the accompanying content with the presentation of the audio-visual stream.

The encoded multimedia stream is then transmitted to the web browser 210, which in turn presents the multimedia stream on a display. As a result, the web browser displays the audio-visual stream together with the accompanying content included in the VBI tokens. The accompanying content in the VBI tokens includes advertisements downloaded from the co-ad server 212.

The VBI tokens further include instructions for the web browser 210 to download advertisements from the co-ad server 212 and/or other audio-visual streams received from the multimedia server 216. The instructions may require the user to activate a banner before the other multimedia streams are presented. An example of an other multimedia stream may be further details on a topic related to the contents of the audio-visual stream for enhanced content presentation.

The data servlet 206 responds to commands, such as pause or fast forward, received from the web browsers 210 during transmission of a program and adjusts any timing synchronization issues, if required, for the web browsers 210. Further, the data servlet 206 communicates with the web browser 210 until the user chooses, for example, another program from the web server 208 or anything that would require the services of the web server 208 such as activating a URL or hyperlink to another web site. The user has the option of concurrently viewing both the media presentation and the web site of the hyperlink; or the media presentation may be terminated and the user only views the web site of the hyperlink.

The web browsers 210 are either Internet Explore or Netscape browsers with an embedded streamed media player: any one of RealPlayer, Windows media player, or Quick Time ORATI player. Each of the client web browsers 210 is also a host for a client applet of the system 190 as well as script that has been embedded in the web pages from the web server 208. The client applet receives VBI tokens, synchronization timing information, and other information of the control file from the data servlet 206 and accordingly synchronizes the accompanying content to the audio-visual stream.

The co-ad servers also provide advertisements according to user preferences. The user preferences are obtained from users signing-up on the web server 208. The user preferences can also be generated from user histories of usage according to a number of known methods. Alternately, another service or agency can also obtain this information for the web server 208. Alternately, part or all of the user profiles may also be stored in cookies on the web browsers 210.

The co-ad server 212 optionally may include an audit applet within each advertisement to provide an audit trail according to known methods in order to obtain statistics on the advertisements activated or accessed by users. The audit applet reports to the web server 208 or ad revenue 216 server or another agency. These audit methods are known in the industry and are not described further.

Where the signal source 200 is a television channel, the broadcast signal is, for example, decoded by an ATI VBI decoder and digitized by a TV digitizer. A real media encoder then encodes the digitized signal, an audio-visual stream.

Source code to substantially achieve the above-described system 190 is disclosed for a better understanding, but without limiting the scope of the present invention. Source codes to the implementation are provided below.

The data servlet 206 and the client applet, while residing on different computer systems, are combined in one computer program. The source code, Ravi Shanker, is written in Java and compiles into both the data servlet 206 and the client applet. A copy is in Appendix A.

The VBI organizer, data filter, URL generator, and enhanced data exporter functions of database computer 204 are provided by the source code Excalibur. The code is written in C and a copy of is in Appendix B. The Excalibur source code has been written for the Linux operation system.

A copy of web server 208 source codes (Cold Fusion: TESsocket, Showtime) are in Appendices C and D. The Showtime source code files in Appendix C compose the website environment for the end-user and display hyperlink triggers and images as communicated by the data servlet and client applet. A description of the Showtime files are:

addcomment.cfm: pop-up for the end-user to make time stamped comments about the presentation;

banner2.cfm: frame for displaying banner image and hyperlink;

buttonbar2.cfm: frame for displaying website controls;

caption2.cfm: pop-up window for displaying close caption text;

comment2.cfm: frame for displaying viewer comments throughout presentation;

community.cfm: frame for launching viewer forums;

data2.cfm: frame for holding presentation data;

linklist2.cfm: frame for displaying hyperlinks throughout presentation;

main2.cfm: webpage which contains all other frames for archived presentations hyperlinks with media;

main3.cfm: webpage which contains all other frames for live presentations of hyperlinks with media;

main4.cfm: webpage which contains all other frames for live presentations of hyperlinks without media;

search.cfm: frame which allows user to use internet search engine during presentation;

selector.cfm: webpage which allows user to choose presentation to watch;

sponsor2.cfm: frame for displaying sponsor, network and station images and hyperlinks;

stream2.cfm: frame for displaying archived streamed media presentation and communicating with data servlet/client applet;

stream3.cfm: frame for displaying live streamed media presentation and communicating with data servlet/client applet;

stream4.cfm: frame for displaying live presentation without streamed media and communicating with data servlet/client applet;

thankyou.cfm: pop-up to thank user for adding comment about presentation.

The TESsocket source code files in Appendix D provide a secure connection between the Linux operation system and the Excalibur program.

The Norpak data decoder interface source code is available from the decoder manufacturer.

Those skilled in the art will also appreciate that the synchronized convergence of the audio visual stream with the concurrent URL's, and further implementing the essence of the spirit and scope of the present invention, can be attained through yet other embodiments. Without limiting the scope of the present invention, some of the possible other embodiments and variants are as follows:

The Internet connection to client web browsers or clients include radio signals, wireless, and land lines.

In the instance where the feed from the associate, or other signal source, is delivered in the form of MPEG 2, or RealPlayer, or Windows Media Player (tm) audio visual streams, in compliance with ATVEF guidelines and standards; this streaming signal is also accompanied by concurrent synchronized “Data channels” or “ATVEF compliant tags or packets”, also conforming to ATVEF, Information Assurance Technical Framework (IATF), AECS, Advanced Television Systems Committee (ATSC), and NABTS, standards and guidelines, in conformity to the synchronized convergence platform.

Further, as new ATVEF, IATF, AECS, ATSC, and NABTS standards evolve and change, all of the aspects of this invention will also apply in those embodiments.

Intervals similar to the VBI's, such as, the Vertical Ancillary Space (VANC) of High Definition Television (HDTV) signals, in accordance with ATSC and Society of Motion Picture and Television Engineers (SMPTE) standards, may also be used by the invention for purposes described herein.

A number of different means for delivering the information in the control file to clients are possible including streaming the VBI tokens to the clients separately from the multimedia stream, and sending the whole control file to the client for execution upon receipt of the multimedia stream.

Although the system is described as transmitting a multimedia stream retrieved from the transmission database, those of skill in the art will appreciate that the multimedia stream may also be transmitted from a live or pre-recorded feed. In these cases, the control file may not require the decoding of VBI tokens.

Those skilled in the art will also appreciate that variations and modifications may be made to the present invention without departing from the spirit and scope thereof as defined by the appended claims.

What is claimed is:

1. A method of controlling a display of accompanying content during a multimedia stream transmission over an Internet connection comprising the steps of:
selecting thematically appropriate content to accompany the multimedia stream; and
dynamically changing the accompanying content during the transmission of the multimedia stream so that the displayed accompanying content is thematically appropriate for the content of the multimedia stream being displayed.

2. The method of claim 1 wherein the accompanying content is dynamically changed in response to changes in the content of the multimedia stream transmission.

3. The method of claim 2 wherein during the selecting step a control file is created, the control file including triggers corresponding to changes in the content of the multimedia stream transmission, the accompanying content being changed in response to the triggers.

4. The method of claim 3 wherein the triggers are vertical blanking interval (VBI) tokens having timestamps corresponding to points along the multimedia stream at which the content thereof changes.

5. The method of claim 1 further comprising the step of changing the location at which the accompanying content is presented to a user.

6. A system for controlling a display of accompanying content during a multimedia stream transmission over an Internet connection, the system comprising:
a selector to select thematically appropriate content to accompany a multimedia stream; and
a multimedia server to dynamically change the accompanying content during the multimedia stream transmission so that the displayed accompanying content is thematically appropriate for the content of the multimedia stream being displayed.

7. The system of claim 6, wherein the accompanying content is dynamically changed in response to changes in the content of the multimedia stream transmission.

8. The system of claim 7, wherein the selector creates a control file, the control file including triggers corresponding to changes in the content of the multimedia stream transmission, the accompanying content being changed in response to the triggers.

9. The system of claim 8, wherein the triggers are VBI tokens having timestamps corresponding to points along the multimedia stream at which the content thereof changes.

10. The system of claim 6, wherein the multimedia server changes the location at which the accompanying content is presented to a user.

11. A computer program product including a computer readable medium having a computer program recorded therein for controlling a display of accompanying content during a multimedia stream transmission over an Internet connection, the computer program comprising:
computer program code to select thematically appropriate content to accompany a multimedia stream; and
computer program code to dynamically change the accompanying content during the transmission of the multimedia stream so that the displayed accompanying content is thematically appropriate for the content of the multimedia stream being displayed.

12. The computer program product of claim 11, wherein the computer program code for changing dynamically changes the accompanying content in response to changes in the content of the multimedia stream transmission.

13. The computer program product of claim 12, wherein the computer program code for selecting creates a control file including triggers corresponding to changes in the content of the multimedia stream transmission, the accompanying content being changed in response to the triggers.

14. A method of controlling a display of accompanying content during a transmission of a multimedia stream over an Internet connection comprising the steps of:
receiving commercial information associated with the multimedia stream;
locating tokens corresponding to accompanying content in the commercial information;
accessing a database for data that is thematically appropriate to the accompanying content;
creating a control file based on the accompanying content;
forwarding the control file to a multimedia server for coordination with the transmission of the multimedia stream; and
executing the control file during transmission of the multimedia stream;
wherein execution of the control file dynamically controls the location and subject matter of accompanying content displayed during the transmission of the multimedia stream so that the displayed accompanying content is thematically appropriate with the content of the multimedia stream being displayed.

15. The method of claim 14 wherein the accompanying content information is contained in VBI tokens.

16. The method of claim 15 further comprising the steps of:
storing the multimedia stream and the control file in a database; and
retrieving the multimedia stream and control file in response to a client request.

17. A method of producing a multimedia stream for transmission over an Internet connection to a web browser, the multimedia stream including an audio-visual stream and accompanying content, the method comprising:
receiving a signal comprising the audio-visual stream and vertical blanking intervals, the vertical blanking intervals comprising textual information on the contents of the audio-visual stream where the textual information is substantially synchronized with the contents of the audio-visual stream;
extracting the textual information and synchronization timing of the textual information in relation to the audio-visual stream from the signal;
selecting accompanying content associated to at least one of the textual information and user preferences of the web browser;
formatting the accompanying content into VBI tokens; and
encoding the audio-visual stream and the VBI tokens where the accompanying content is presented and changed according to the VBI tokens by the web browser so that the accompanying content is in substantial synchronization with presentation of the contents of the audio-visual stream.

18. The method of claim 17, wherein the accompanying content comprises at least one of advertisements, links, and other multimedia streams.

19. The method of claim 17, wherein the accompanying content is thematically appropriate to the contents of the audio-visual stream.

20. The method of claim 18, wherein the advertisements are retrieved from databases maintained by advertisers.

21. The method of claim 18, wherein the links related to the contents are located by searching at least one thesaurus database using the textual information as keywords.

22. A method of producing a multimedia stream for transmission over an Internet connection to a web browser, the multimedia stream including an audio-visual stream and accompanying content, the method comprising:
receiving a signal comprising the audio-visual stream and vertical blanking intervals, the vertical blanking intervals comprising textual information on the contents of the audio-visual stream where the textual information is substantially synchronized with the contents of the audio-visual stream;
extracting the textual information and synchronization timing of the textual information in relation to the audio-visual stream from the signal;
selecting accompanying content associated to at least one of the textual information and user preferences of the web browser;
formatting the accompanying content into VBI tokens; and
encoding the synchronization timing and the VBI tokens into a control file for storage, and in response to a user request, the control file is retrieved for encoding the audio-visual stream and the VBI tokens where the accompanying content is presented and changed according to the VBI tokens by the web browser so that the accompanying content is in substantial synchronization with presentation of the contents of the audio-visual stream.

23. The method of claim 22, wherein the accompanying content comprises at least one of advertisements, links, and other multimedia streams.

24. The method of claim 22, wherein the accompanying content is thematically appropriate to the contents of the audio-visual stream.

25. The method of claim 23, wherein the advertisements are retrieved from databases maintained by advertisers.

26. The method of claim 23, wherein the links related to the contents are located by searching at least one thesaurus database using the textual information as keywords.

27. A method of presenting a multimedia stream for transmission over an Internet connection to a web browser, the multimedia stream including an audio-visual stream and accompanying content, the method comprising:
receiving a signal comprising the audio-visual stream and vertical blanking intervals, the vertical blanking intervals comprising textual information on the contents of the audio-visual stream where the textual information is substantially synchronized with the contents of the audio-visual stream;
extracting the textual information and synchronization timing of the textual information in relation to the audio-visual stream from the signal;
selecting accompanying content associated to at least one of the textual information and user preferences of the web browser;
formatting the accompanying content into VBI tokens;
encoding the synchronization timing and the VBI tokens into a control file;
storing the control file and the audio-visual stream;
receiving a request from the web browser for the multimedia stream and in response retrieving the control file and audio-visual stream;
encoding the audio-visual stream and the VBI tokens for the multimedia stream; and
transmitting the multimedia stream to the web browser;
where the accompanying content is presented and changed according to the VBI tokens by the web browser so that the accompanying content is in substantial synchronization with presentation of the contents of the audio-visual stream.

28. The method of claim 27, wherein the accompanying content comprises at least one of advertisements, links, and other multimedia streams.

29. The method of claim 27, wherein the accompanying content is thematically appropriate to the contents of the audio-visual stream.

30. The method of claim 28, wherein the advertisements are retrieved by the web browser from databases maintained by advertisers according to instructions in the VBI tokens.

31. The method of claim 28, wherein the links related to the contents are located by searching at least one thesaurus database using the textual information as keywords.

32. A method of presenting a multimedia stream and associated VBI tokens received over an Internet connection on a web browser, the multimedia stream including an audio-visual stream, the VBI tokens including accompanying content, the method comprising:
requesting the multimedia stream from a web portal;
connecting to a multimedia server to receive the multimedia stream;
receiving the multimedia stream and the VBI tokens from the multimedia server;
extracting the audio-visual stream and the VBI tokens; and
presenting the audio-visual stream and presenting and changing the accompanying content according to the VBI tokens;
where the VBI tokens and the audio-visual stream are encoded such that the accompanying content is presented and changed according to the VBI tokens by the web browser so that the accompanying content is in substantial synchronization with presentation of the contents of the audio-visual stream.

33. The method of claim 32, wherein the accompanying content comprises at least one of advertisements, links, and other multimedia streams.

34. The method of claim 32, wherein the accompanying content is thematically appropriate to the contents of the audio-visual stream.

35. The method of claim 33, wherein the advertisements are retrieved by the web browser from databases maintained by advertisers according to instructions in the VBI tokens.

36. The method of claim 33, wherein the links related to the contents are located by searching at least one thesaurus database using the textual information as keywords.

37. The method of claim 32, wherein the VBI tokens is received separately from the multimedia stream.
